(19) United States
(12) Patent Application Publication
(10) Pub. No.: US 2021/0018741 A1
(43) Pub. Date: Jan. 21, 2021

(54) Microscope System and Method for Controlling a Microscope System of this Type

(71) Applicant: Leica Microsystems CMS GmbH, Wetzlar (DE)

(72) Inventors: Karin SCHWAB, Wetzlar-Garbenheim (DE); Jiahao PAN, Singapore (SG); Stefan HUBER, Schoenau (DE); Stefan FABRIS, Bad Langensalza (DE)

(21) Appl. No.: 17/040,020

(22) PCT Filed: Mar. 13, 2019
(86) PCT No.: PCT/EP2019/056245

§ 371 Date: Sep. 21, 2020

(30) Foreign Application Priority Data
Mar. 23, 2018 (DE) 10 2018 107 033.0

(51) Int. Cl. G02B 21/36; G06F 3/0484; H04N 5/272; G06F 3/0482; H04N 5/232; G02B 21/12; G02B 21/26

(52) U.S. Cl. CPC G02B 21/365; G06F 3/04847; H04N 5/272; G06F 3/04845; G06F 3/04883; H04N 5/23203; G02B 21/368; G02B 21/12; G02B 21/26; G06F 3/0482

(57) ABSTRACT

A microscope system and a method for controlling the microscope system have a microscope with several microscope components electrically adjustable and/or activatable via a control apparatus at least one objective, one illumination device, and a camera generating a digital microscopic image, and having a control and display device generating control signals for controlling at least one of the components and displaying the microscopic image; the control and display device is connected to the control apparatus and comprising a display area; the operating element with several operating fields; one or several operating fields configured such that the control and display device, upon selection of an operating field, controls one or several of the components and/or means for modifying settings in the control and display device; upon selection of the operating element as a whole, it becomes modified, via within the display area, regarding its position, its size, shape.

### RELATED APPLICATIONS

This Application is a U.S. National Stage Under 35 USC § 371 of International Application PCT/EP2019/056245, filed on Mar. 13, 2019, which in turn claims priority to German Patent Application DE 10 2018 107 033.0, filed Mar. 23, 2018, both of which are incorporated herein by reference in their entirety.

### FIELD OF THE INVENTION

The present invention relates to a microscope system, to a method for controlling such a microscope system, and to a computer program and a computer program product for implementing such a method. The present invention relates in general to the field of digital microscopes.

### BACKGROUND OF THE INVENTION

Microscope systems having a microscope having adjustable microscope components that encompass at least one microscope objective, at least one microscope illumination device, and (at least) one microscope camera for generating a microscopic image, are known from the existing art for a variety of purposes. Specimens to be investigated can be, for example, selectably imaged in magnified fashion with transmitted bright-field illumination or with incident fluorescence illumination. The specimens can be, for example, cell cultures that are being investigated for tumor diagnosis and/or cancer research. Questions to be addressed are, for example, the existence of growth (number of cells), angiogenesis (formation of new blood vessels), transfection efficiency (number of cells having a transferred-in gene), wound healing (time required for separated cell regions to grow together), or confluence (degree to which the surface of a culture vessel is covered with attached cells).

WO 03/081235 A1 discloses a method for investigating cells with a microscope that comprises a microscope stage that is movable in computer-assisted fashion, and a camera for generating a microscopic image. The microscope stage carries the cell cultures; the camera transfers the microscopic image to a computer, which displays it on a monitor. After an overview image has been acquired, a cell of interest is identified and is then viewed at higher magnification in centered fashion.

EP 2 023 127 A1 discloses a method and an apparatus for investigating biological samples, the intention being to observe a biological activity of the sample continuously over a long period of time. The apparatus comprises a microscope having a temperature-regulated microscope stage, as well as a microscope camera for generating a microscopic image that is presented on a monitor.

Microscope systems of the kind recited should perform the possible investigation methods as automatically as possible, and supply investigation results, and if possible also summarize the ascertained metadata, in visualized fashion, in which context the generated microscopic images can optimally be displayed and/or saved as a live image or still image. Remote control of the microscope system, and/or remote display of the microscopic images that are generated, are also desirable. Remote control of microscopic image acquisition, and remote evaluation, can thus be accomplished in particular for longer-duration investigations.

### SUMMARY OF THE INVENTION

The object of the present invention is therefore to describe a microscope system, and a corresponding method for controlling it, by means of which a largely automated, and in particular remotely controllable, sample investigation process of this kind is made possible in simple fashion.

This object is achieved by a microscope system according to the present invention, by a method according to the present invention for controlling such a microscope system, and by a computer program and a computer program product for implementing such a method, in accordance with the independent claims. Advantageous embodiments are evident from the respective dependent claims and from the description below.

A microscope system according to the present invention comprises a microscope having several microscope components that are electrically adjustable and/or activatable by way of a control apparatus of the microscope, encompassing at least one microscope objective, at least one microscope illumination device, and at least one microscope camera that generates a digital microscopic image, and a control and display device (20) that generates control signals for controlling at least one of the adjustable and/or activatable microscope components and for displaying the microscopic image. The control and display device is communicatingly connected to the control apparatus of the microscope and comprises a display area on which at least a portion of the generated digital microscopic image is displayed, overlaid on which is a virtual graphical operating element. The operating element comprises several operating fields, one or several operating fields being configured in such a way that the control and display device, upon selection of an operating field, applies control to one or several of the adjustable and/or activatable microscope components and/or to means for modifying settings in the control and display device. The operating element is embodied in such a way that upon selection of the operating element as a whole, it becomes modified, by means of gesture control within the display area, in terms of its position and/or its size and/or shape.

In other words, the microscope system firstly comprises at least one microscope having microscope components, adjustable and/or activatable via a control apparatus of the microscope, for generating a microscopic image, those components encompassing at least one microscope illumination device, (at least) one microscope objective, and (at least) one microscope camera. By adjustment or activation of such microscope components, for example, a microscope illumination device can be switched on or off or its illumination intensity can be adjusted; the desired microscope objective can be swung into the beam path or the one that is present can be activated (this also being intended to encompass simply the presence of a fixed objective in the beam path); and/or the microscope camera is switched on or off or its exposure time (imaging time) and/or signal gain are adjusted. The microscope system furthermore comprises a control and display device, in particular in the form of a remote control and display device, for controlling at least one of the adjustable microscope components and for displaying the microscopic image, the control and display device comprising a display area for displaying at least a portion of the generated microscopic image. An, in particular, remote user can thereby generate and inspect a microscopic image. An operating element is graphically overlaid on the displayed microscopic image, the operating element comprising several selectable operating fields (e.g. control buttons), one or several of those operating fields being configured in such a way that upon selection or actuation of an operating field, control is applied, via the control and display device or via a processor present in the control and display device (hereinafter also referred to as a “computing unit of the control and display device”), to one or several of the adjustable or activatable microscope components that are communicatingly connected to the control apparatus of the microscope; by selection of a corresponding operating field, for example, a specific or selectable microscope illumination and the appropriate (or existing) microscope objective can be selected, and the microscope camera can be switched on for generation of a microscopic image. As the investigation continues, for example, the illumination intensity of the microscope illumination device and/or the exposure time and/or the signal gain of the microscope camera can be adjusted by way of one or several corresponding operating fields in order to optimize the microscopic image. Alternatively or additionally, upon selection of an operating field control can be applied, via the control and display device or the above-defined “computing unit” in the control and display device, to means for modifying settings in the control and display device relating to the display area. It is thereby possible, for example, to perform a digital displacement or digital magnification (digital zoom) or a magnification of a portion of the displayed image.

According to the present invention, the operating element is embodied in such a way that upon selection of the operating element itself, it becomes modified by means of gesture control in terms of its position and/or its size and/or its shape. What is meant here by “selection” of an operating field or of the operating element is selection or actuation, for example, by tapping with a user's finger on a touchscreen or clicking with the cursor of an input keyboard. “Gesture control” is understood here to mean automatic recognition of gestures performed by persons, the gestures being detected by the control and display device or by the above-defined “computing unit” in the control and display device. Any body posture or body movement can, in principle, represent a gesture. The recognition of hand gestures, however, is of the greatest importance. A variant of gesture recognition is recognition of so-called mouse gestures in the context of inputs using the cursor of an input keyboard or mouse.

Advantageously, a control and display device having a touch display is used, for example a tablet or a smartphone. The gesture control systems known from the sector of tablets and mobile telephones relate to simple selection of an operating field by tapping, shifting an object by touching and then a swiping motion, preferably with a finger; or zooming an object by touching with two (or more) fingers and then correspondingly moving the fingers apart or together. In the context of the present invention as well, the gestures are detected in the control and display device, and control signals are generated which serve to control at least one of the adjustable and/or activatable microscope components and to display the microscopic image.

Several microscopes can also be present in a microscope system, and control can be applied to them, selectably via a single control and display device (tablet), by a control apparatus configured in the form of a server.

The microscope system according to the present invention makes possible a particularly ergonomic capability for controlling (including, in particular, remotely) the microscope components and the display functions in the display device. For example, the operating element can be displayed in magnified fashion, further operating fields possibly being overlaid, or being displayed smaller, while certain less important, or all, operating fields are hidden. Alternatively or additionally, upon selection and shifting of the operating element as a whole, it is displaced within the displayed microscopic image and/or modified in terms of its size and/or shape. Thanks to this configuration of the operating element, it can on the one hand be presented at a position in the display area at which it is as unobtrusive as possible in the displayed microscopic image and/or covers as little image information as possible. On the other hand, for example after selection of a specific image acquisition mode, it can be reduced in size by a corresponding predefined gesture (e.g. pulling the fingers together), and operating fields not required in the mode can be hidden so that image viewing is interfered with as little as possible or, for easier selection of a different or modified image acquisition mode, they can be enlarged back to full size by a corresponding different predefined gesture (e.g. spreading the fingers apart). The size and shape of the operating element can thus be adapted to the ergonomic needs of a user so that, for example, the microscope system can easily be controlled by a (remote) user on a tablet computer having a touchscreen. All in all, the type of presentation and the capability for selection and gesture control of the operating element and of the operating fields make possible user-friendly, reliable, and easier control of a microscope system, or interaction with such a microscope system, in particular also by remote users.

It has proven to be particularly advantageous in this context if, upon selection of the operating element, it is displaceable by displacement in the form of a corresponding gesture within the display area, and upon displacement into a predefined edge region of the display area, the operating element assumes a modified size and/or shape by the fact that the operating fields become rearranged. Otherwise the operating element would be only partly visible upon displacement beyond the edge region, so that specific operating fields would no longer be displayed. This can be prevented by the fact that the operating fields that would otherwise “disappear” are arranged in a new size or shape. For this, the operating element is adapted, in its modified shape, to the dimensions and the shape of the edge region.

It is particularly advantageous in this context if operating fields are arranged within an inner region of the display area in a circular or rectangular operating element, and in the edge region of the display area are arranged in an arc-shaped or ribbon-shaped operating element. If the operating element is subsequently displaced to the edge of the display area, the circular or rectangular operating element then becomes an arc- or ribbon-shaped element that is located at the edge and continues to show all the operating fields. If the control and display device is, for example, a tablet computer having a touchscreen, an arc-shaped operating element at one edge of the touchscreen is then particularly appropriate, especially if selection of an operating field is accomplished with the user's finger, since a movement of the fingertip usually follows a curved path, so that a specific one of several operating fields can easily be selected, for example, by tapping with the fingertip of a hand that, with the other fingers, can in fact hold the pad or the tablet computer; or can be actuated, for example, in the case of a slider (see below). This makes possible ergonomically favorable, reliable, and simple technical control of the microscope system.

In a further advantageous embodiment, the operating element is configured in such a way that upon selection of an operating field, one or several further operating fields are displayed. Selection of an operating field thus opens, for example, a (sub)menu having further pertinent operating fields. Alternatively or additionally, selection of an operating field can, for example, make visible a slider that constitutes a further relevant operating field. A slider of this kind permits, for example after selection of a specific microscope illumination mode, ergonomically favorable adjustment of the brightness, in particular via adjustment of the illumination intensity of the relevant illumination device and/or the exposure time and/or signal gain of the camera. It is ergonomically particularly advantageous if the slider or the further operating field or fields are adapted in shape and size to the (still-displayed or hitherto displayed) operating element, i.e. for example if they surround the circular operating element annularly or in annular-segment fashion, or are adjacent in arc-shaped fashion to the arc-shaped operating element.

In a further advantageous embodiment, at least one of the operating fields is configured in such a way that upon selection thereof, control is applied to adjustable microscope components for generation of an incident fluorescence image. Upon activation of a corresponding operating field, for example, the desired incident illumination source of the incident fluorescence illumination device is switched on, the microscope camera is put into operation and, if necessary, any further microscope settings are made.

It is particularly advantageous if in this case, only one of possibly several LED incident illumination sources, and the microscope camera, constituting adjustable microscope components, are switched on and controlled. It is also appropriate in this case to overlay a slider as an additional operating field for controlling the illumination intensity of the LED and/or the exposure time or signal gain of the camera, so that the resulting image brightness can be optimally adjusted in a more user-friendly manner.

In a further advantageous embodiment, at least one of the operating fields is configured in such a way that upon selection thereof, control is applied to adjustable microscope components for generation of a bright-field transmitted image, in particular in phase contrast. Upon activation of a corresponding operating field, for example, the desired illumination source of the bright-field transmitted illumination device is switched on and the microscope camera is put into operation. If necessary, any further microscope settings are made.

It is particularly advantageous and technically simple if in this case control is applied to only one LED transmitted illumination source and to the microscope camera, constituting adjustable microscope components. In this case it is also once again appropriate to overlay a slider as an additional operating field for controlling the illumination and/or the exposure time or signal gain of the camera.

In a further advantageous embodiment, at least one of the operating fields is configured in such a way that upon selection thereof, control is applied to the microscope camera for generation of a live image or a still image. The corresponding operating field can, upon actuation or selection, switch respectively back and forth between a live image and still image.

In a further advantageous embodiment, at least one of the operating fields is configured in such a way that upon selection thereof, a displayed image is transferred in digital form into a memory of the control and display device. Investigation results can thereby be documented in simple fashion in the form of images.

In a further advantageous embodiment, at least one of the operating fields is configured in such a way that upon selection thereof, the display area and/or the display of the microscopic image are modified. For example, by selection or actuation of an operating field, the display area can be modified in such a way that any menu bars at the edge of the screen are hidden, so that the region of the displayed microscopic image becomes enlarged. Alternatively, digital and/or optical zooming of the microscopic image, or an adjustment of the brightness and/or contrast, can be accomplished. The at least one operating field is preferably configured in such a way that upon selection thereof, the display is respectively switched over between a full-image mode and a menu image mode. In the full-image mode, menu bars that are otherwise present, for example, at the edge of the screen are hidden, so that the display area for the microscopic image becomes larger.

In a further advantageous embodiment, at least one of the operating fields is configured in such a way that upon selection thereof, acquisition and storage of several sequential images is initiated. The development of confluence can be quantitatively assessed by evaluating such sequential images.

In a further advantageous embodiment, at least one of the operating fields is configured in such a way that upon selection thereof, the intensity of the microscope illumination, i.e. the illumination intensity of the illumination device, and/or the exposure time or signal gain of the microscope camera, can be controlled and modified. Reference is made in this regard to the statements made above.

In a further advantageous embodiment, at least one of the operating fields is configured in such a way that upon selection thereof, control is applied to means for modifying the position of the microscope stage and/or the position of the microscope objective. This embodiment requires that means for modifying the position of the microscope stage and/or of the microscope objective be associated with the adjustable microscope components. The microscope stage can be displaceable in an X-Y direction and optionally also a Z direction, the microscope objective usually only in a Z direction.

The invention further relates to a method for controlling a microscope system having a microscope having several microscope components that are electrically adjustable and/or activatable via a control apparatus of the microscope, and having a control and display device that generates control signals for controlling at least one of the adjustable and/or activatable microscope components and for displaying a microscopic image. The method encompasses the following steps:

generating a communication connection between the control and display device and the control apparatus of the microscope;

generating control signals by means of the control and display device, at least one of the adjustable and/or activatable microscope components, and/or the display of the microscopic image on the control and display device, being controlled with the control signals;

generating a digital microscopic image by means of at least one microscope objective, one microscope illumination device, and one microscope camera constituting, in particular, electrically adjustable and/or activatable microscope components of the microscope;

displaying at least a portion of the generated digital microscopic image on a display area of the control and display device, a virtual graphical operating element that comprises several selectable operating fields being overlaid on the digital microscopic image, such that

upon selection of an operating field, control is applied by the control and display device (or by a processor present therein) to one or several of the adjustable and/or activatable microscope components and/or to means for modifying settings in the control and display device, and such that

upon selection of the operating element as a whole, it becomes modified, by means of gesture control within the display area, in terms of its position and/or its size and/or shape.

Advantages and embodiments of the method according to the present invention are evident analogously from the description of the microscope system according to the present invention, so that another explanation of the embodiments hereinafter can be omitted and they are therefore reproduced in merely cursory form.

An advantageous embodiment is characterized in that upon selection of the operating element as a whole, it is displaced by displacement within the display area; and that the operating element, upon displacement into an edge region of the display area, assumes a modified shape, the arrangement of the operating fields being modified.

A further advantageous embodiment is characterized in that the operating fields are arranged within an inner region of the display area in a circular operating element; and that the operating element, in its modified shape in the edge region of the display area, is shaped like an arc-shaped or ribbon-shaped operating element.

A further advantageous embodiment is characterized in that the operating fields are arranged within an inner region of the display area in a rectangular operating element; and that the operating element, in its modified shape in the edge region of the display area, is shaped like an arc-shaped or ribbon-shaped operating element.

A further advantageous embodiment is characterized in that upon selection of at least one of the operating fields, at least one further operating field is additionally displayed in the display area.

A further advantageous embodiment is characterized in that the at least one further operating field additionally displayed in the display area is presented as a slider which permits a value adjustment to at least one microscope component controlled by the selected operating field and/or to a means for modifying settings in the control and display device.

A further advantageous embodiment is characterized in that upon selection of at least one of the operating fields, control is applied to adjustable and/or activatable microscope components for generation of an incident fluorescence image.

A further advantageous embodiment is characterized in that control is applied to an LED incident illumination source and to the microscope camera, constituting adjustable and/or activatable microscope components.

A further advantageous embodiment is characterized in that upon selection of at least one of the operating fields, control is applied to adjustable and/or activatable microscope components for generation of a transmitted bright-field image.

A further advantageous embodiment is characterized in that control is applied to an LED transmitted illumination source and to the microscope camera, constituting adjustable and/or activatable microscope components.

A further advantageous embodiment is characterized in that upon selection of at least one of the operating fields, control is applied to the microscope camera for generation of a live image or a still image.

A further advantageous embodiment is characterized in that upon selection of at least one of the operating fields, a displayed image is transferred in digital form into a memory of the control and display device.

A further advantageous embodiment is characterized in that upon selection of at least one of the operating fields, the display area and/or the display of the microscopic image are modified.

A further advantageous embodiment is characterized in that upon selection of the at least one operating field, the display is switched over between a full-image mode and a menu image mode.

A further advantageous embodiment is characterized in that upon selection of at least one of the operating fields, acquisition and storage of several sequential microscopic images is initiated.

A further advantageous embodiment is characterized in that upon selection of at least one of the operating fields, control is applied to the illumination intensity of the at least one microscope illumination device and/or to the exposure time of the microscope camera.

A further advantageous embodiment, utilizing a microscope having a microscope stage adjustable in terms of its position and/or a microscope objective adjustable in terms of its position, is characterized in that upon selection of at least one of the operating fields, control is applied to means for modifying the position of the microscope stage and/or the position of the microscope objective.

The invention further relates to a computer program for implementing a method according to the present invention for controlling a microscope system according to the present invention when the computer program executes on a computer, in particular on the computing unit of the control and display device of a microscope system according to the present invention.

Lastly, the invention further relates to a computer program product on which a computer program according to the present invention is stored, for example a USB stick, a diskette, a CD-ROM, or another suitable computer program memory.

Further advantages and embodiments of the invention are evident from the description and the appended drawings.

It is understood that the features recited above and those yet to be explained below are usable not only in the respective combination indicated, but also in other combinations or in isolation, without departing from the scope of the present invention.

### BRIEF DESCRIPTION OF THE DRAWINGS

The invention is schematically depicted in the drawings on the basis of an exemplifying embodiment and will be described in detail below with reference to the drawings, in which:

FIG. 1 schematically depicts a microscope system according to the present invention;

FIG. 2 schematically depicts a display area of the control and display device of FIG. 1 having an exemplifying operating element;

FIG. 3 shows what is displayed in FIG. 2, a specific operating field being selected;

FIG. 4 shows a display area having an arc-shaped operating element in the edge region;

FIG. 5 shows a display area having an arc-shaped operating element in the left edge region; and

FIG. 6 shows a display area having an arc-shaped operating element in the lower edge region.

### DETAILED DESCRIPTION OF THE PREFERRED EMBODIMENTS

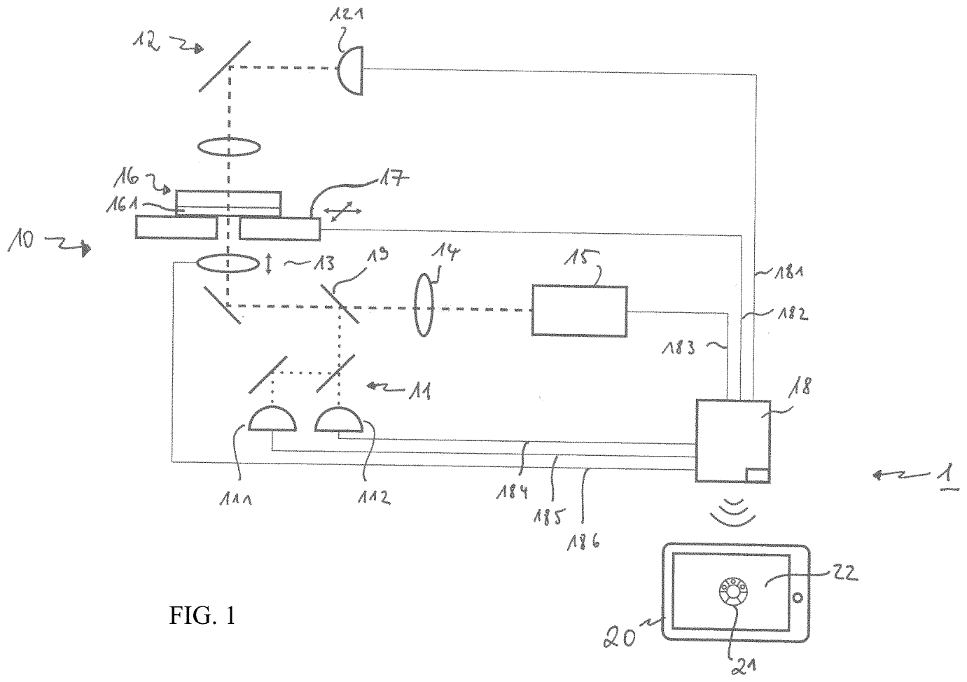

Microscope system 1 schematically depicted in FIG. 1 encompasses a microscope 10 as well as a control and display device 20. Microscope 10 possesses adjustable microscope components to which control can be applied via a control apparatus 18 of microscope 10. FIG. 1 shows, for example, a digital wide-field microscope 10 in which it is possible to switch over selectably between incident fluorescence illumination and transmitted bright-field illumination, two (or more) types of fluorescence illumination being available, and the transmitted bright-field illumination being configured as phase contrast illumination. The incident illumination device is labeled 11 and encompasses, as elements depicted here in essence, two different LED incident illumination sources 111 and 112 whose illumination beam paths can be coupled, via beam splitters or deflection mirrors that are not further characterized, into the incident illumination axis. The microscope objective is labeled 13. The transmitted illumination device is labeled 12; once again, only the essential elements are depicted, in particular an LED transmitted illumination source 121 whose illumination beam path can be directed via a deflection mirror and a lens (not further characterized) onto the specimen plane. The microscope stage of microscope 10 is labeled 17. It possesses, for the purpose of transmitted illumination, an opening above which specimen 161 that is to be investigated is placed. In the case in which cell cultures are being investigated, they are usually located in a Petri dish constituting a specimen carrier 16. The microscope stage can be displaceable in a horizontal direction (X-Y direction). A vertical displacement in a Z direction can also be provided. Microscope objective 13 can be displaceable in a Z direction. The corresponding positioning members for respectively displacing microscope 17 and objective 13 are known per se and are not depicted separately in FIG. 1. The same applies to the positioning members for activation and shutoff, and for adjustment of the illumination intensity, of LED illumination sources 111, 112, and 121. The corresponding positioning members are connected via control leads 181, 182, 184, 185, and 186 to control device 18 of microscope 10.

Microscope 10 furthermore comprises a tube lens 14 and a microscope camera 15. Microscope camera 15 is connected via control lead 183 to control apparatus 18.

Microscope system 1 that is depicted further encompasses control and display device 20, which comprises a computing unit (not additionally depicted here), i.e. a processor, by way of which device 20 is communicatingly connected to control apparatus 18 of microscope 10. In the exemplifying embodiment depicted, this communicating connection is established via a wireless WLAN connection. Control and display device 20 comprises a display area 22 for displaying at least a portion of the generated microscopic image, and for displaying an operating element 21 overlaid on the displayed microscopic image. Further properties of this operating element 21 will be explained in further detail with reference to the subsequent Figures.

The manner of operation of microscope system 1 depicted here will be explained as follows based on the exemplifying embodiment below: To generate a transmitted bright-field image, a user selects the corresponding operating field on operating element 21 of his or her control and display device 20. In the exemplifying embodiment depicted, that device 20 is a pad or a tablet computer. The computing unit, or the processor of device 20 which is ordinarily present, is connected via WLAN to control apparatus 18 of microscope 10, so that the corresponding control instruction can be implemented by control apparatus 18 of microscope 10, and control can be applied to the corresponding microscope components. Transmitted illumination LED 121 is switched on via control lead 181. The illumination beam path arrives at sample 161 via the deflection mirror and the lens of transmitted illumination device 12. The resulting observation beam path propagates via microscope objective 13 and a deflection mirror (not further characterized) and a beam splitter 19, so as to be imaged by tube lens 14 into microscope camera 15. Camera 15 was also switched on via control lead 183 upon selection of the generation of a transmitted bright-field image, and any appropriate camera settings (exposure time and sensor parameters, such as signal gain) were made. The camera acquires a transmitted bright-field image in phase contrast, and control apparatus 18 transfers the generated microscopic image to display device 20, which presents it in display area 22.

In this exemplifying embodiment, a user has two options for generating an incident fluorescence image. Depending on the staining, the sample can be excited with blue light so that a substantially green emission image occurs, or can be excited with green light so that a red emission image occurs. Microscope camera 15, however, usually generates a black-and-white image that is then displayed respectively as a green or red false-color image. For generation respectively of a green or red incident fluorescence image of this kind, the user can select the operating fields on operating element 21, which are correspondingly colored respectively green and red for easier selection. The computing unit (processor) in display and control device 20 in turn communicates with control apparatus 18 of the microscope, said apparatus applying control, depending on the selection, via control leads 184 or 185 to one of the respective incident illumination LEDs 112 or 111. The corresponding LED is switched on and a specific illumination intensity, which can be preset, is set. By way of the deflection mirrors or beam splitters (not further characterized in FIG. 1) of incident fluorescence illumination device 11, the illumination beam path of the corresponding illumination source 111 or 112 travels via beam splitter 19 and a further deflection mirror into objective 13, from which it is focused onto sample 161. The resulting observation beam path travels in reverse order to beam splitter 19 and from there via tube lens 14 to microscope camera 15, which generates a corresponding incident fluorescence image presented in red or green. The generated microscopic image is transferred via control apparatus 18 of microscope 10 to display device 20, and presented there in display area 22.

It is possible in principle for microscope 10 to be operated in this exemplifying embodiment with microscope stage 17 in a fixed position, and for any necessary positioning of sample 161 to be performed by shifting the specimen carrier or Petri dish 16. On the other hand, for convenient operation, the position of microscope stage 17 can also be adjusted manually. Lastly, the corresponding positioning member or members for an adjustment of microscope stage 17 can also be connected via a control lead 182 to control apparatus 18 of microscope 10, so that a corresponding modification of the position of microscope stage 17 can also be effected by a user via display and control device 20.

Lastly, it is useful to adjust microscope objective 13 manually via a focusing drive in such a way that a sharp specimen image is produced. That focusing, i.e. shifting of microscope objective 13 in a Z direction, can in turn also be accomplished in automated fashion, by the fact that the corresponding positioning member is connected via control lead 186 to control apparatus 18 of microscope 10. A user can thereby in turn perform focusing, or initiate autofocusing, on display and control device 20.

The possible control functions using the corresponding operating fields of an operating element 21 will be explained in further detail below.

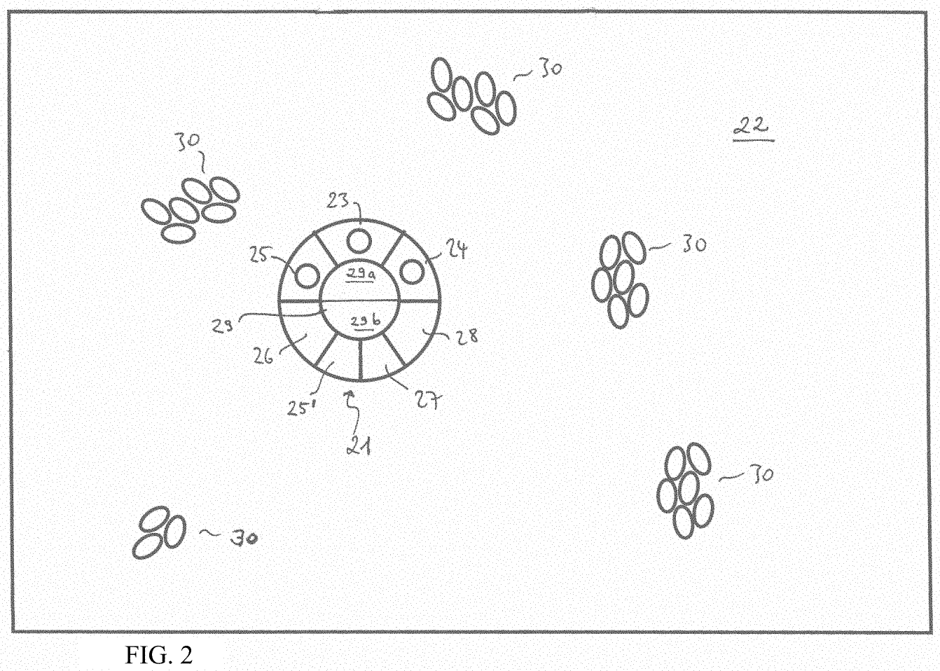

FIG. 2 shows, as a user interface, a display area 22 having schematically depicted biological cells 30 within the displayed microscopic image that is displayed on the entire display area 22. Operating element 21 is overlaid on this microscopic image, operating element 21 comprising, in this exemplifying embodiment, a variety of operating fields 23 to 29. For example, generation of a green incident fluorescence image in the manner referred to above with reference to FIG. 1 can be initiated by selecting operating field 23. Operating element 23 is advantageously, for that purpose, colored green at least in the circular inner region. Selecting operating field 25, for example, causes a red incident fluorescence image to be generated in the manner discussed above. Usefully, operating field 25 is red in color at least in the inner circular region. Selection of operating field 24 causes a phase contrast incident bright-field image to be generated in the manner discussed above. Operating field 24 is white in color in the inner circular region.

A further operating field 29 comprises two sub-fields 29a and 29b. Selection thereof switches over selectably between generation of a live image or of a still image. When operating field 29a is selected, for example, a live image is displayed, whereas a still image is displayed when operating field 29b is selected. The live image allows observation of cell processes, for example reproduction or movement thereof. The still image retains the most recently acquired camera image; the illumination source can be switched off in order to reduce stress on the sample. Upon selection of operating field 28, the displayed image or still image is transferred in digital form into a memory of control and display device 20. For that purpose, the computing unit of display device 20 transfers the corresponding image data into the memory of display device 20.

When selected, a further operating field 27, for example, modifies the display area, by the fact that a switchover occurs respectively between a full-image mode as depicted in FIG. 2, and a menu image mode. In the menu image mode, further menu items for controlling or evaluating acquired microscopic images are present. Hiding the corresponding menu bars causes the display area for the displayed microscopic image to become larger.

A further operating field 26, when selected, initiates acquisition and storage of several microscopic images successively in time. When this operating field 26 is selected, a further submenu in the form of further operating fields is overlaid for controlling image acquisition. The sequentially acquired microscopic images can be evaluated, for example, in terms of confluence or wound healing.

Lastly, a further operating field (yet to be depicted here) can be present, upon selection of which a red and a green incident fluorescence image are displayed in overlaid fashion. These two images are then acquired successively in time from one another and separately from one another, and overlaid. In principle, however, it is also possible to generate these images simultaneously, in which case any differences in the brightness of the two fluorescence images must be equalized.

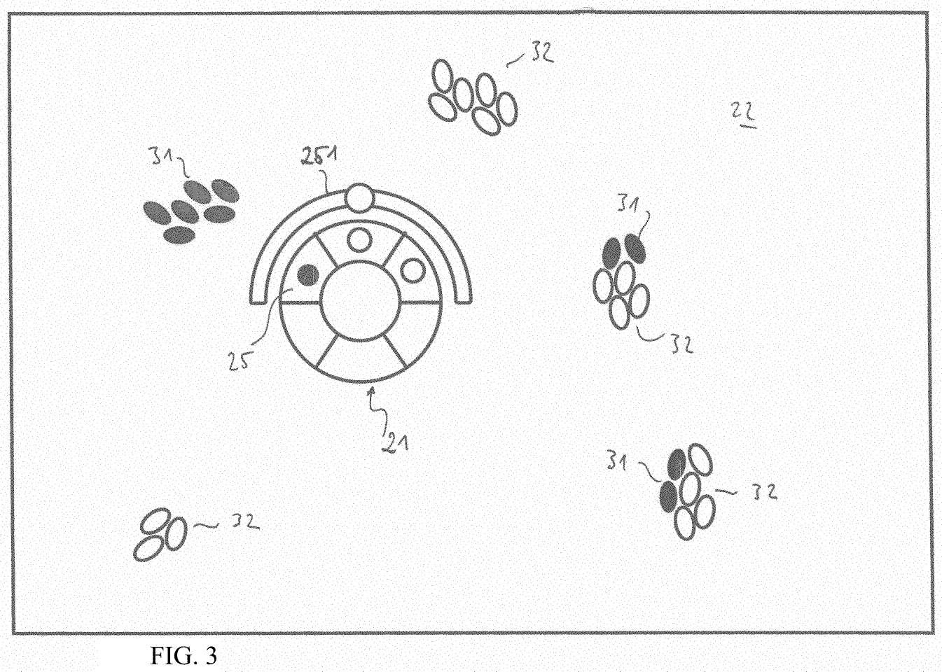

In a microscope system 1 depicted in FIG. 1, having a microscope stage 17 whose position is adjustable and to which control can be applied via control apparatus 18, and/or having a microscope objective 13 whose position is adjustable and to which control can likewise be applied via control apparatus 18, it is useful to provide further operating fields (not depicted here) to allow the position of the microscope stage and/or the microscope objective to be modified. An operating field for modifying the position of microscope objective 13 is present, for example, upon selection of which a slider (see FIG. 3), constituting a further operating field, is overlaid, by actuation of which the user can then effect a Z displacement of objective 13. Corresponding control signals are transferred from the computing unit of control and display device 20 to control apparatus 18 of microscope 10, that control apparatus 18 applying control, via control lead 186, to the corresponding positioning member for Z displacement of objective 13. Additionally or alternatively, a further operating field (not depicted here) can be present, upon selection of which one or several further operating fields, in particular in the form of sliders, are overlaid, by actuation of which microscope stage 17 can be shifted in one or several directions in an X and/or Y and/or Z direction. The corresponding positioning members of microscope stage 17 are connected for that purpose, via control lead 182, to control apparatus 18 of microscope 10.

FIG. 3 shows display area 22 of control and display device 20 after activation, by selection of operating field 25, of an incident fluorescence illumination for generation of a red incident fluorescence image. In the context of a touchscreen, selection is accomplished in user-friendly fashion by tapping operating field 25. As already described above, after selection of operating field 25, the corresponding incident illumination LED 111, 112 is activated, i.e. switched on, and a preset illumination intensity is established, and at the same time microscope camera 15 is switched on and any predefined camera settings are implemented. The generated microscopic image is displayed in display area 22. The (red) colored fluorescing cells 31, and non-fluorescing cells 32, are clearly apparent. Simultaneously with the selection of operating field 25, a slider 251 is overlaid as a further operating field. The shape of slider 251 is adapted to the shape of operating element 21 and permits an ergonomically favorable adjustment of image brightness, in particular by shifting the schematically indicated button along the path of slider 251 with a user's finger. An adjustment of this kind preferably modifies the illumination intensity of the respective corresponding incident illumination LED 111, 112 and applies control to parameters of camera 15, such as exposure time and sensor sensitivity, so that the dynamics of the camera can be optimally adapted.

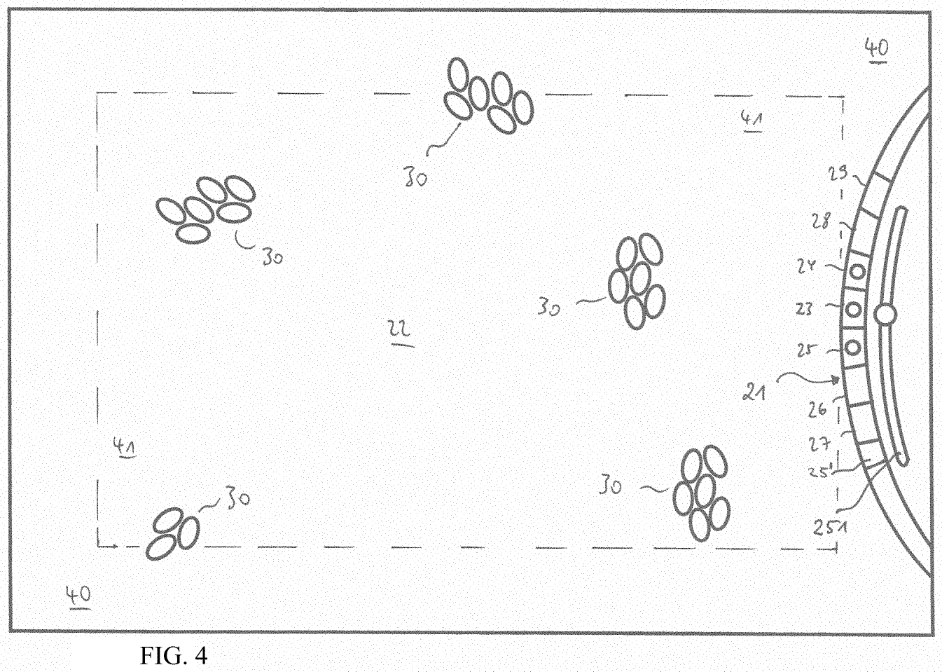

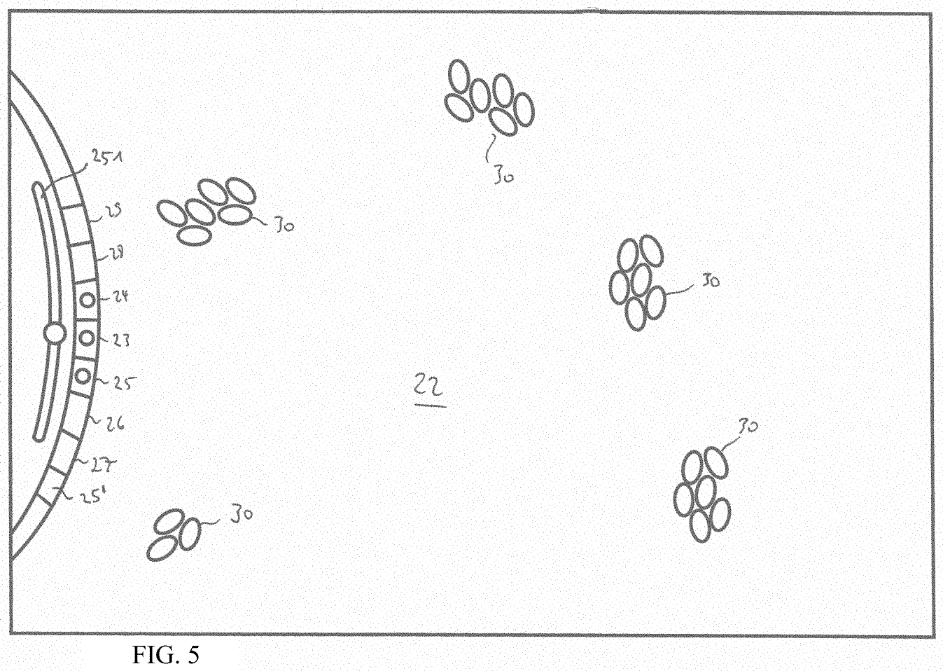

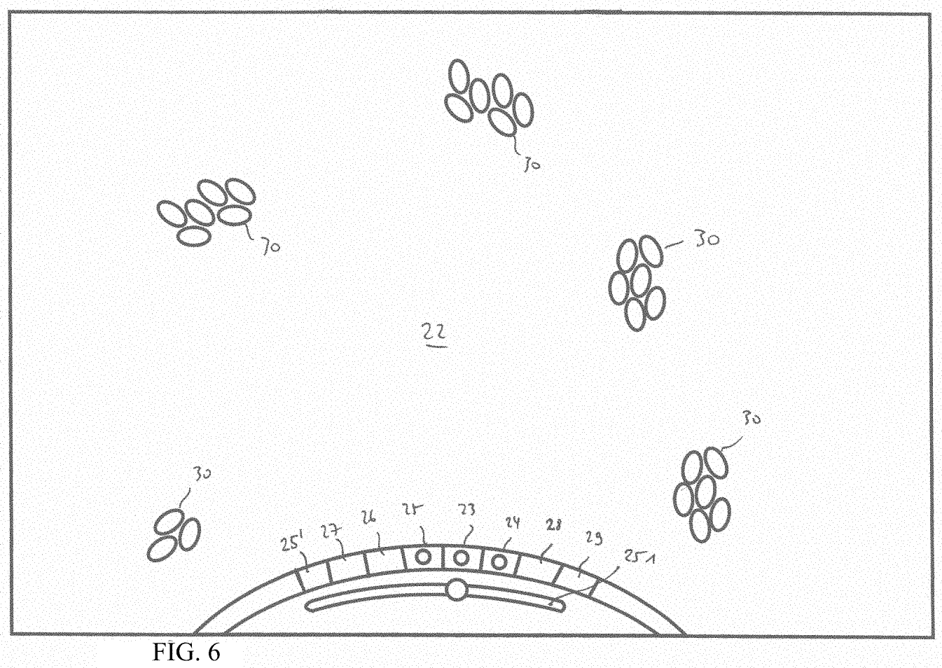

FIGS. 4 to 6 again show display area 22 of control and display device 20 in a manner similar to FIG. 2. By selecting operating element 21 itself by tapping and holding as a gesture control, a user can, for example on a touchscreen, shift operating field 21 shown in FIG. 2 or 3, by subsequent shifting, to any position in an inner region 41 of display area 22. If, however, operating element 21 is shifted into edge region 40 that is adjacent to inner region 41, as illustrated in FIG. 4 by the dashed line, the shape and size of operating element 21 change in the manner depicted in FIG. 4. If operating element 21 is shifted into the right portion of edge region 40, it assumes there the arc shape that is shown; if it is shifted into the left portion of edge region 40, it assumes the arc shape depicted in FIG. 5; and if it is shifted into the lower portion of edge region 40, it assumes the arc shape shown in FIG. 6. Operating element 21 can also experience a change in shape if it is moved against the upper edge of the display area. It can, however, also remain unchanged, since an adaptation of the shape is not obligatorily necessary because a touch display, for example on a tablet computer or a mobile telephone, typically is not touched at the upper edge since that is not ergonomic.

The arc-shaped operating elements 21 depicted in FIGS. 4 to 6 have the following advantage: On the one hand, as little as possible of the displayed microscopic image is covered, in particular when the specimen region of interest is displayed in the inner region of display area 22. On the other hand, the arc-shaped operating element 21 permits an ergonomically very advantageous selection of the individual operating fields 23 to 29, and of slider 251, by way of a finger motion, for example of the thumb or the index finger, in a natural manner. This is the case especially when a tablet computer is used as control and display device 20. Said computer is typically held at the right or left edge of the image, so that the fingers or thumb can ergonomically touch the individual operating fields 23 to 29 and slider 251 of the arc-shaped operating element 21. The position of the arc-shaped operating element 21 at the lower edge of the image proves to be particularly advantageous when the tablet computer is held in landscape format on a stand that, for example, is set up on a desk. A user can then ergonomically place his or her hand, with the palm downward, on the desk and conveniently reach and operate the individual operating fields 23 to 29, and slider 251, with an extended index finger.

### PARTS LIST

1 Microscope system
10 Microscope
11 Incident illumination device
111 LED incident illumination source
112 LED incident illumination source
12 Transmitted illumination device
121 LED transmitted illumination device
13 Microscope objective
14 Tube lens
15 Microscope camera
16 Specimen carrier, Petri dish
161 Specimen, sample
17 Microscope stage
18 Control device
181 to 186 Control leads
19 Beam splitter
20 Control and display device
21 Operating element
22 Display area
23 to 29 Operating fields
29a Operating field
29b Operating field
251 Slider
30 Cells
31 Fluorescing cells
32 Non-fluorescing cells
40 Edge region
41 Inner region

1. A microscope system comprising:
a microscope having several microscope components and a control apparatus for electrically adjusting and/or activating said several microscope components;
at least one microscope objective, at least one microscope illumination device, and a microscope camera for generating a digital microscopic image;
a control and display device serving to generate control signals for controlling at least one of the several adjustable and/or activatable microscope components and for displaying the digital microscopic image, the control and display device being communicatingly connected to the control apparatus and comprising a display area for displaying at least a portion of the digital microscopic image with overlaid a virtual graphical operating element;
the operating element comprising several operating fields;
at least one of the several operating fields being configured such that upon selection of one of the several operating fields the control and display device, applies control to the at least one of the several of the adjustable and/or activatable microscope components and/or to means for modifying settings in the control and display device; and
the operating element being embodied in such a way that upon selection of the operating element as a whole, a position and/or a size and/or a shape of the operating element becomes modified by means of gesture control within the display area.

2. The microscope system according to claim 1, wherein the operating element is displaceable by displacement within the display area upon selection of the operating element as a whole; and wherein upon displacement into an edge region of the display area the operating element assumes a modified size and/or shape in accordance with modification of an arrangement of the operating fields.

3. The microscope system according to claim 2, wherein the operating fields are arranged within an inner region of the display area in the operating element having a circular shape; and wherein the operating element, in its modified shape in the edge region of the display area, is shaped like an arc-shaped or ribbon-shaped operating element.

4. The microscope system according to claim 2, wherein the operating fields are arranged within an inner region of the display area in the operating element having a rectangular shape; and wherein the operating element, in its modified shape in the edge region of the display area, is shaped like an arc-shaped or ribbon-shaped operating element.

5. The microscope system according to one of claims 1 to 4, wherein at least one of the operating fields is configured in such a way that upon selection of said at least of the operating fields, at least one further operating field is additionally displayed in the display area.

6. The microscope system according to claim 5, wherein the at least one further operating field additionally displayed in the display area is a slider that permits a value adjustment of at least one microscope component controlled by the at least one of the operating fields and/or of the means for modifying settings in the control and display device.

7. The microscope system according to claim 1, wherein at least one of the operating fields is configured in such a way that upon selection of the at least one of the operating fields, control is applied to the adjustable and/or activatable microscope components to generate an incident fluorescence image.

8. The microscope system according to claim 7, wherein control is applied to an LED incident illumination source and to the microscope camera.

9. The microscope system according to claim 1, wherein at least one of the operating fields is configured in such a way that upon selection of the at least one of the operating fields, control is applied to the adjustable and/or activatable microscope components to generate a bright-field transmitted image.

10. The microscope system according to claim 9, wherein control is applied to an LED transmitted illumination source and to the microscope camera.

11. The microscope system according to claim 1, wherein at least one of the operating fields is configured in such a way that upon selection of the at least one of the operating fields, control is applied to the microscope camera for generating a live image or a still image.

12. The microscope system according to claim 1, wherein at least one of the operating fields is configured in such a way that upon selection of the at least one of the operating fields, a displayed image is transferred in a digital form into a memory of the control and display device.

13. The microscope system according to claim 1, wherein at least one of the operating fields is configured in such a way that upon selection of the at least one of the operating fields, the display area and/or the display of the microscopic image are modified.

14. The microscope system according to claim 13, wherein upon selection of the at least one operating field, the display is switched over between a full-image mode and a menu image mode.

15. The microscope system according to claim 1, wherein at least one of the operating fields is configured in such a way that upon selection of the at least one of the operating fields-, acquisition and storage of several sequential images is initiated.

16. The microscope system according to claim 1, wherein at least one of the operating fields is configured in such a way that upon selection of the at least one of the operating fields, control is applied to an illumination intensity of the at least one microscope illumination device and/or to an exposure time of the microscope camera.

17. The microscope system according to claim 1, further comprising a microscope stage adjustable in its position, wherein the microscope objective is adjustable in its position, and wherein at least one of the several operating fields is configured in such a way that upon selection thereof, control is applied to means for modifying a position of the microscope stage and/or a position of the microscope objective.

18. A method for controlling a microscope system comprising:
providing a microscope having several microscope components and a control apparatus for electrically adjusting and/or activating said several microscope components, and a control and display device for generating control signals for controlling at least one of the several microscope components and for displaying a microscopic image;
generating a communication connection between the control and display device and the control apparatus of the microscope;
generating control signals by means of the control and display device and using the control signals for controlling at least one of the several microscope components; and/or the display of the microscopic image;
generating a digital microscopic image by means of at least one microscope objective, at least one microscope illumination device, and a microscope camera, constituting electrically adjustable and/or activatable microscope components of the microscope;
displaying at least a portion of the digital microscopic image on a display area of the control and display device, and a virtual graphical operating element comprising several selectable operating fields overlaid on the digital microscopic image; wherein
upon selecting an operating field applying control by the control and display device to the at least one of the several microscope components and/or to means for modifying settings in the control and display device; and wherein
upon selecting the virtual graphical operating element as a whole, using gesture control within the display area to modify a position and/or size and/or shape the virtual graphical operating element, in terms of its.

19. The method according to claim 18, wherein upon selecting the operating element as a whole, the operating element is displaced by displacement within the display area and wherein-upon being displaced into an edge region of the display area, the operating element assumes a modified shape and the several operating fields become modified.

20. The method according to claim 19, further comprising arranging the several operating fields within an inner region of the display area in a circular operating element, wherein the operating element in its modified shape in the edge region of the display area, is shaped as an arc-shaped or ribbon-shaped operating element.

21. The method according to claim 19, further comprising arranging the several operating fields within an inner region of the display area in a rectangular operating element, wherein the operating element in its modified shape in the edge region of the display area, is shaped as an arc-shaped or ribbon-shaped operating element.

22. The method according to claim 18, wherein upon selecting at least one of the operating fields, at least one further operating field is additionally displayed in the display area.

23. The method according to claim 22, further comprising presenting the at least one further rating field additionally displayed in the display area is as a slider permitting a value adjustment of at least one microscope component controlled by the at least one of the operating fields and/or to means for modifying settings in the control and display device.

24. The method according to claim 18, further comprising generating an incident fluorescence image by controlling the microscope components upon selecting at least one of the several operating fields.

25. The method according to claim 24, further comprising applying control to an LED incident illumination source and to the microscope camera, constituting adjustable and/or activatable microscope components.

26. The method according claim 18, further comprising generating a transmitted bright-field image by controlling the microscope components upon selecting at least one of the several operating fields.

27. The method according to claim 26, further comprising applying control to an LED transmitted illumination source and to the microscope camera, constituting adjustable and/or activatable microscope components.

28. The method according to claim 18, further comprising generating a live image or a still image by controlling the microscope camera (15) upon selecting at least one of the operating fields.

29. The method according to claim 18, further comprising transferring a displayed image in a digital form into a memory of the control and display device upon selecting at least one of the operating fields.

30. The method according to claim 18, further comprising modifying the display area and/or the display of the microscopic image upon selecting at least one of the operating fields.

31. The method according to claim 30, further comprising switching the display over between a full-image mode and a menu image mode upon selecting of the at least one of the operating fields.

32. The method according to claim 18, further comprising initiating acquisition and storage of several sequential microscopic images upon selecting at least one of the operating fields.

33. The method according to claim 18, further comprising controlling illumination intensity of the at least one microscope illumination device and/or an exposure time of the microscope camera (15) upon selecting at least one of the operating fields.

34. The method according to claim 18, further comprising utilizing a microscope having a microscope stage adjustable in its position, and/or a microscope objective adjustable in its position, wherein upon selecting at least one of the operating fields, control is applied to means for modifying the position of the microscope stage and/or the position of the microscope objective.

35. A computer program for implementing the method in accordance with claim 18, wherein the computer program executes on a computer associated with a control and display device of a microscope system comprising:
a microscope having several microscope components and a control apparatus for electrically adjusting and/or activating said several microscope components;
at least one microscope objective, at least one microscope illumination device, and a microscope camera for generating a digital microscopic image;
a control and display device serving to generate control signals for controlling at least one of the several adjustable and/or activatable microscope components and for displaying the digital microscopic image, the control and display device being communicatingly connected to the control apparatus and comprising a display area for displaying at least a portion of the digital microscopic image with overlaid a virtual graphical operating element;
the operating element comprising several operating fields;
at least one of the several operating fields being configured such that upon selection of one of the several operating fields the control and display device, applies control to the at least one of the several of the adjustable and/or activatable microscope components and/or to means for modifying settings in the control and display device; and
the operating element being embodied in such a way that upon selection of the operating element as a whole, a position and/or a size and/or a shape of the operating element becomes modified by means of gesture control within the display area.

36. A computer program product having stored on it the computer program according to claim 35, wherein the computer program implements the method in accordance with claim 18, wherein the computer program executes on a computer associated with a control and display device of a microscope system comprising:
a microscope having several microscope components and a control apparatus for electrically adjusting and/or activating said several microscope components;
at least one microscope objective, at least one microscope illumination device, and a microscope camera for generating a digital microscopic image;
a control and display device serving to generate control signals for controlling at least one of the several adjustable and/or activatable microscope components and for displaying the digital microscopic image, the control and display device being communicatingly connected to the control apparatus and comprising a display area for displaying at least a portion of the digital microscopic image with overlaid a virtual graphical operating element;
the operating element comprising several operating fields;
at least one of the several operating fields being configured such that upon selection of one of the several operating fields the control and display device, applies control to the at least one of the several of the adjustable and/or activatable microscope components and/or to means for modifying settings in the control and display device; and
the operating element being embodied in such a way that upon selection of the operating element as a whole, a position and/or a site and/or a shape of the operating element becomes a modified by means of gesture control within the display area.
